(19) United States
(12) Patent Application Publication
(10) Pub. No.: US 2026/0065253 A1
(43) Pub. Date: Mar. 5, 2026

(54) Computer-Enabled Cart System Leveraging Machine Learning Models for Content Selection Based on Sensor Data Describing User Interactions

(71) Applicant: Maplebear Inc., San Francisco, CA (US)

(72) Inventors: Brent Scheibelhut, Toronto (CA); Naval Shah, Toronto (CA); Charles Wesley, San Diego, CA (US); Mark Oberemk, Toronto (CA)

(21) Appl. No.: 18/821,677

(22) Filed: Aug. 30, 2024

(51) Int. Cl. G06Q 20/20; G01G 19/52; G06V 10/70; G06V 20/52

(52) U.S. Cl. CPC G06Q 20/208; G01G 19/52; G06V 10/70; G06V 20/52

(57) ABSTRACT

A smart cart system accounts for edge cases in user interactions by leveraging sensor data and machine-learning models of a smart cart system. For example, a smart cart system uses sensor data to detect when a user removes an item from the smart cart system and presents content to the user on a display of the smart cart system based on the removed item. The smart cart system captures images of the storage area and applies an item identification model to the images to identify the item removed from the storage area. The smart cart system identifies a set of candidate items based on location sensor data describing a location of the smart cart system when the item was removed and computes presentation scores for each of the set of candidate items based on item data for each item the removed item.

### BACKGROUND

Smart cart systems use sensors and on-board computing systems to track items and users within the environment and within a storage area of the smart cart. For example, a smart cart system may use load sensors to track the weight of items in a storage area of the smart cart or may use cameras and computer-vision-based machine-learning models to identify items that are located in the storage area. However, smart cart systems are generally configured for particular use cases that are most common. For example, smart cart systems are generally configured to detect new items that are added to the cart and the functionalities of the smart cart system are generally focused on that scenario as a primary use case. However, these smart cart systems fail to account for edge cases in user interactions and can thereby fail to effectively perform the core functionalities of the smart cart system.

### SUMMARY

A smart cart system accounts for edge cases in user interactions by leveraging sensor data and machine-learning models of a smart cart system to provide additional functionalities based on user interactions with the smart cart system. For example, a smart cart system may use sensor data to detect when a user removes an item from the smart cart system and present content to the user on a display of the smart cart system based on the removed item. For example, the smart cart system may use a load sensor to detect a decrease in the weight of a storage area to determine that an item has been removed from the storage area of the smart cart system. The smart cart system may capture images of the storage area and apply an item identification model to the images to identify the item removed from the storage area. The smart cart system may identify a set of candidate items based on location sensor data describing a location of the smart cart system when the item was removed. For example, the smart cart system may compare the location data to a model of an environment around the smart cart system to identify items that are within a threshold distance of the smart cart system when the item is removed. The smart cart system may compute presentation scores for each of the set of candidate items based on item data for each item and item data for the removed item by comparing item embeddings for the items or by applying a specially-trained machine-learning model to the item data. The smart cart may then use the presentation scores to update a display of the smart cart system with content based on a selected candidate item.

By leveraging sensor data and machine-learning models to identify edge case user interactions with a smart device, this disclosure describes an improvement to the technical fields of smart devices and smart cart systems by describing a configuration of these systems that provides better functionalities during user interactions. Specifically, these systems use an additional signal of item removals from a smart cart system's storage area to more effectively select content to be displayed to users.

### BRIEF DESCRIPTION OF DRAWINGS

FIG. 1 illustrates an example system environment for a smart cart system, in accordance with one or more illustrative embodiments.

FIG. 2 is a flowchart illustrating an example method for selecting items for presentation on a display of a smart cart system based on a removed item, in accordance with some embodiments.

FIG. 3 illustrates an example data flow through a smart cart system, in accordance with some embodiments.

### DETAILED DESCRIPTION

### Example System Environment for Smart Cart System

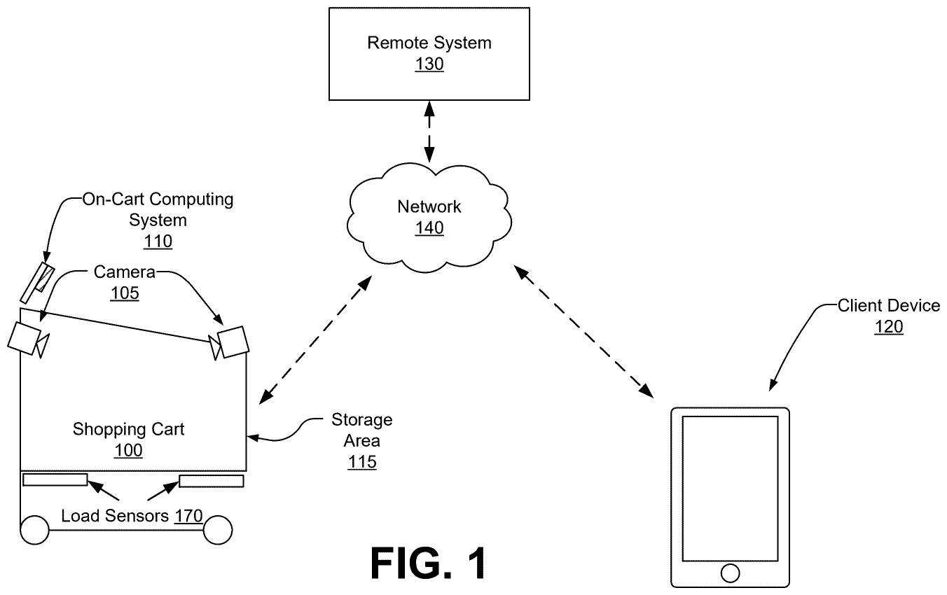

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors). The term “smart cart system” may be used herein to refer to the shopping cart 100, the cameras 105, the on-cart computing system 110, and any sensors coupled to the shopping cart 100.

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. These models and techniques may be generally referred to herein as “item identification models.” As an example, the on-cart computing system 110 applies a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier is encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charge the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

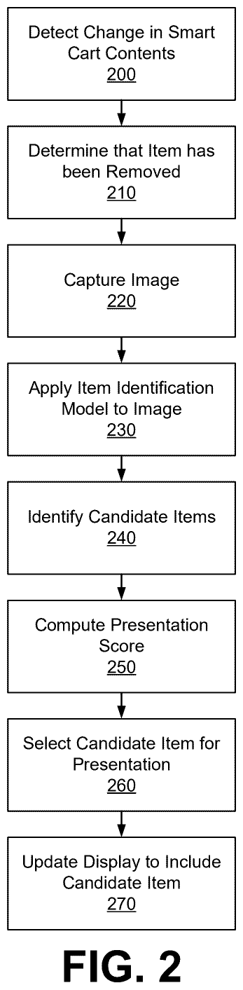

FIG. 2 is a flowchart illustrating an example method for selecting items for presentation on a display of a smart cart system based on a removed item, in accordance with some embodiments. Alternative embodiments may include more, fewer, or different steps from those illustrated in FIG. 2 and the steps may be performed in a different order from that illustrated. Furthermore, while the steps below are described as being performed by an on-cart computing system of a smart cart system, some or all of the steps may be performed by a computing system that is in communication with the smart cart system over a network (e.g., the remote system 130).

The smart cart system detects 200 a change in the contents of a storage area of the smart cart system based on sensor data captured by sensors coupled to the smart cart system. For example, the smart cart system may include a load sensor coupled to the storage area to collect load data describing the weight of the items stored in the storage area, a proximity sensor that measures proximity sensor data describing items that move towards or away from the storage area, or a camera that captures image data depicting the contents of the storage area. The smart cart system may detect the change by detecting a change in the captured sensor data. For example, the smart cart system may detect a change in the weight of the contents of the cart, an item approaching or moving away from the storage area, or a change in the number of items depicted in images of the contents of the cart.

The smart cart system determines 210 whether an item has been removed based on the sensor data. For example, the smart cart system may determine that the weight of the items in the storage area has decreased. Similarly, the smart cart system may apply an item identification model to captured image data and may determine that fewer items are present in the storage area than at some previous time. In some embodiments, the smart cart system uses a machine-learning model that is trained to identify user poses to identify actions performed by users with regards to the contents of the smart cart system. U.S. Pat. No. 18,499,154, entitled “Image-Based User Pose Detection for User Action Prediction” and filed Oct. 31, 2023, describes a pose detection model that predicts whether a user has added or removed an item from a smart cart system and is incorporated by reference.

If the smart cart system detects a change in the contents of the storage area, the smart cart system captures 220 an image of the contents of the storage area and applies 230 an item identification model to the captured image to identify the removed item. To identify the removed item, the smart cart system may use the item identification model to identify a set of items in the storage area before the change to a set of items after the change and may use the difference to identify which item was removed from the cart. Alternatively, the smart cart system may use an image depicting the item in-transit out of the storage area (e.g., in the user's hand as the user is removing the item) to identify the removed item. In some embodiments, the smart cart system captures multiple images to identify the removed item. For example, the smart cart system may include multiple cameras capturing images at the same time or cameras capturing a series of images over a period of time.

The smart cart system identifies 240 a set of candidate items that may be presented to the user in response to the user removing the item from the storage area of the smart cart system. The smart cart system may apply a set of criteria for generating the set of candidate items. For example, the smart cart system may require that each of the set of candidate items be located within a threshold distance of the smart cart system when the item was removed from the storage area. The smart cart system may capture location data describing the location of the smart cart within a store (e.g., GPS data, Bluetooth data, RFID data, wheel encoder data) and may compare that location to a store map (e.g., a planogram) to determine which items are located within a threshold distance of the smart cart system. The smart cart system may also limit the set of candidate items to items that have an eligibility characteristic. For example, the smart cart system may only select items that are sponsored for the set of candidate items or may only select items that are higher or lower in price than the removed item.

The smart cart system computes 250 a presentation score for each of the candidate items. A presentation score is a score that represents a predicted performance of the candidate item if the candidate item is selected for presentation to the user through a display of the smart cart system. The smart cart system computes a presentation score for a candidate item based on item data describing the removed item and item data describing the candidate item. For example, the item data for each item may include attributes of the item such as the size, color, weight, stock keeping unit (SKU), or serial number for the item. The item data may further include purchasing rules associated with each item, if they exist. In some embodiments, the item data for the items includes an embedding that describes the item in a latent space. The smart cart system may use these item embeddings to compare a candidate item and the removed item by measuring a distance, dot product, or cosine similarity between the two embeddings and compute the presentation score for the candidate item based on the comparison.

In some embodiments, the smart cart system uses a machine learning model that is trained to compute presentation scores for a candidate item based on item data for the candidate item and the removed item. The machine learning model may be trained to predict a likelihood that a user will perform a target action if content relating to the candidate item is displayed to the user. The target action may be that the user interacts with the content through the display, that the user adds the candidate item to the storage area of the smart cart system, or that the user converts on the candidate item. To train the machine-learning model, a set of training examples may be generated, where each training example includes item data for a removed item, item data for a candidate item that was presented to a user on a display of a smart cart system in response to the removed item being removed, and a label indicating whether the user performed the target action. The machine-learning model may be trained by applying the model to each training example, comparing the output of the model to the label using a loss function, and backpropagating through the model to update the model based on the training example.

The smart cart system may use additional data to generate presentation scores for candidate items beyond item data. For example, the smart cart system may use user data describing characteristics of a user who has established a session with the smart cart system to better identify candidate items of interest to the user. Similarly, the smart cart system may use contextual data describing a context of the smart cart system (e.g., other items in the storage area, the location of the smart cart system within the environment, the time of day, or the day of the week) to generate the presentation scores for the candidate items. In some embodiments, this contextual data includes direct user feedback to the smart cart system. For example, in response to the smart cart system identifying the removed item, the smart cart system may update a display of the smart cart system with a user interface requesting feedback from the user indicating why the user has removed the item. This user interface may include user interface elements with options for the user to select from. The smart cart system may feed the user's selection of one of these options as context data to the generation of the presentation scores for the candidate items. In some embodiments, the machine-learning model for generating presentation scores receives user data or context data as an input for computing presentation scores.

The smart cart system selects 260 one or more candidate items to present based on the presentation scores. For example, the smart cart system may rank the candidate items based on their presentation scores and may select the top n candidate items. The smart cart system updates 270 a display of the smart cart system to include content describing the selected one or more candidate items. For example, the smart cart system may display item data describing a candidate item, such as the candidate item's name, an image of the candidate item, or a text description of the candidate item. The smart cart system may also display a user interface element that allows the user to navigate in the store from the smart cart system's current location to a location for the candidate item. In some embodiments, the smart cart system receives the content for the candidate item from a remote system.

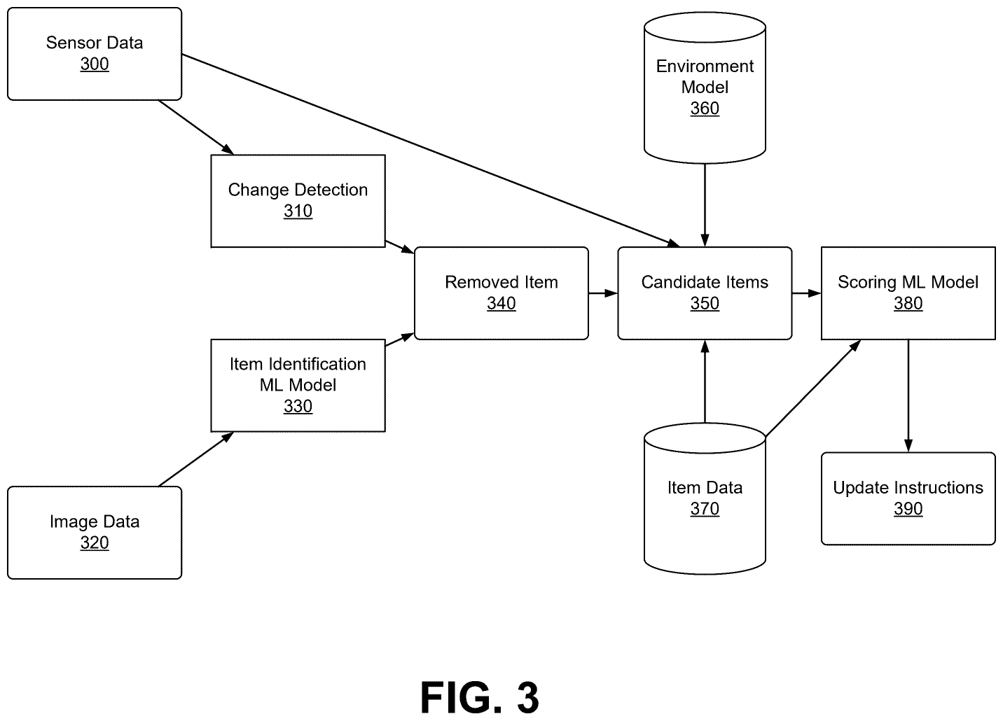

FIG. 3 illustrates an example data flow through a smart cart system, in accordance with some embodiments. The smart cart system captures sensor data 300 using sensors of the smart cart system to detect a change 310 in the contents of a storage area of the smart cart system. The smart cart system captures image data 320 and uses an item identification ML model 330 to identify the item 340 removed from the storage area of the smart cart system. The smart cart system identifies a set of candidate items 350 based on location sensor data 300, an environmental model 360 describing an environment around the smart cart system, and item data 370 describing the removed item and the candidate items. The smart cart system applies a scoring ML model 380 to the item data for the candidate items 350 and the removed item 340 to select a candidate item to present to a user. The smart cart system generates instructions 390 to update the display of the smart cart system to include content describing the selected candidate item.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
detecting, by an on-cart computing system of a smart cart system, a change in contents of a storage area of the smart cart system based on sensor data captured by a set of sensors coupled to the smart cart system;
determining, based on the sensor data, that an item has been removed from the storage area of the smart cart system by a user of the smart cart system;
responsive to detecting the change in the contents of the storage area, capturing an image using a camera coupled to the smart cart system;
applying an item identification model to the captured image to identify the item removed from the storage area of the smart cart system, wherein the item identification model is a machine-learning model that is trained to identify items based on images that depict the items;
identifying a plurality of candidate items based on location data captured by a location sensor of the smart cart system, wherein the location data describes a location of the smart cart system when the item was removed from the storage area of the smart cart system;
computing a presentation score for each of the plurality of candidate items based on item data describing the item removed from the smart cart system and item data describing a corresponding candidate item;
selecting a candidate item for presentation to the user based on the computed presentation scores for the plurality of candidate items; and
updating a display of the smart cart system to present content describing the selected candidate item.

2. The method of claim 1, wherein the sensor data comprises load data from a load sensor coupled to the storage area of the smart cart system, and wherein determining that an item has been removed from the storage area comprises:
measuring, at a first time, a first weight of items in the storage area of the smart cart system based on load data captured by the load sensor;
measuring, at a second time after the first time, a second weight of items in the storage area of the smart cart system based on load data captured by the load sensor;
comparing the first weight to the second weight; and
responsive to the first weight being greater than the second weight, determining that an item has been removed from the storage area.

3. The method of claim 1, wherein determining that an item has been removed from the storage area comprises:
identifying a first set of items in the storage area at a first time based on a first image captured by the camera;
identifying a second set of items in the storage area at a second time after the first time based on a second image captured by the camera;
comparing the first set of items and the second set of items; and
responsive to the first set of items being larger than the second set of items, determining that an item has been removed from the storage area.

4. The method of claim 3, wherein applying the item identification model to identify the item removed from the storage area comprises:
identifying an item that is in the first set of items and not in the second set of items.

5. The method of claim 1, wherein the item identification model is at least one of a barcode detection model, an optical character recognition model, or an image embedding model.

6. The method of claim 1, wherein identifying the plurality of candidate items based on location data comprises:
comparing the location of the smart cart system to a model of an environment around the smart cart system.

7. The method of claim 6, wherein identifying the plurality of candidate items based on location data comprises:
identifying, based on the model of the environment, a set of items located within a threshold distance of the location of the smart cart system.

8. The method of claim 1, wherein computing a presentation score for a candidate item comprises:
applying a machine-learning model to the item data describing the item removed from the smart cart system and item data describing the candidate item, wherein the machine-learning model is trained to generate presentation scores based on a set of training examples, wherein each training example comprises item data for a candidate item, item data for an item removed from a smart cart system, and a label indicating whether a user performed a target interaction in response to being presented with content relating to the candidate item after removing the removed item.

9. The method of claim 1, wherein computing the presentation score for each candidate item comprises:
computing the presentation score based on user data describing the user of the smart cart system or context data describing a context of the smart cart system.

10. The method of claim 9, wherein computing the presentation score for each candidate item comprises:
computing the presentation score based on the context data, wherein the context data comprises a selection of a user of a user interface element indicating a reason for removing the item removed from the smart cart system.

11. A non-transitory computer-readable medium storing instructions that, when executed by a processor, cause the processor to perform operations comprising:
detecting, by an on-cart computing system of a smart cart system, a change in contents of a storage area of the smart cart system based on sensor data captured by a set of sensors coupled to the smart cart system;
determining, based on the sensor data, that an item has been removed from the storage area of the smart cart system by a user of the smart cart system;
responsive to detecting the change in the contents of the storage area, capturing an image using a camera coupled to the smart cart system;
applying an item identification model to the captured image to identify the item removed from the storage area of the smart cart system, wherein the item identification model is a machine-learning model that is trained to identify items based on images that depict the items;
identifying a plurality of candidate items based on location data captured by a location sensor of the smart cart system, wherein the location data describes a location of the smart cart system when the item was removed from the storage area of the smart cart system;
computing a presentation score for each of the plurality of candidate items based on item data describing the item removed from the smart cart system and item data describing a corresponding candidate item;
selecting a candidate item for presentation to the user based on the computed presentation scores for the plurality of candidate items; and
updating a display of the smart cart system to present content describing the selected candidate item.

12. The non-transitory computer-readable medium of claim 11, wherein the sensor data comprises load data from a load sensor coupled to the storage area of the smart cart system, and wherein determining that an item has been removed from the storage area comprises:
measuring, at a first time, a first weight of items in the storage area of the smart cart system based on load data captured by the load sensor;
measuring, at a second time after the first time, a second weight of items in the storage area of the smart cart system based on load data captured by the load sensor;
comparing the first weight to the second weight; and
responsive to the first weight being greater than the second weight, determining that an item has been removed from the storage area.

13. The non-transitory computer-readable medium of claim 11, wherein determining that an item has been removed from the storage area comprises:
identifying a first set of items in the storage area at a first time based on a first image captured by the camera;
identifying a second set of items in the storage area at a second time after the first time based on a second image captured by the camera;
comparing the first set of items and the second set of items; and
responsive to the first set of items being larger than the second set of items, determining that an item has been removed from the storage area.

14. The non-transitory computer-readable medium of claim 13, wherein applying the item identification model to identify the item removed from the storage area comprises:
identifying an item that is in the first set of items and not in the second set of items.

15. The non-transitory computer-readable medium of claim 11, wherein the item identification model is at least one of a barcode detection model, an optical character recognition model, or an image embedding model.

16. The non-transitory computer-readable medium of claim 11, wherein identifying the plurality of candidate items based on location data comprises:
comparing the location of the smart cart system to a model of an environment around the smart cart system.

17. The non-transitory computer-readable medium of claim 16, wherein identifying the plurality of candidate items based on location data comprises:
identifying, based on the model of the environment, a set of items located within a threshold distance of the location of the smart cart system.

18. The non-transitory computer-readable medium of claim 11, wherein computing a presentation score for a candidate item comprises:
applying a machine-learning model to the item data describing the item removed from the smart cart system and item data describing the candidate item, wherein the machine-learning model is trained to generate presentation scores based on a set of training examples, wherein each training example comprises item data for a candidate item, item data for an item removed from a smart cart system, and a label indicating whether a user performed a target interaction in response to being presented with content relating to the candidate item after removing the removed item.

19. The non-transitory computer-readable medium of claim 11, wherein computing the presentation score for each candidate item comprises:
computing the presentation score based on user data describing the user of the smart cart system or context data describing a context of the smart cart system.

20. A system comprising:
a processor; and
a non-transitory computer-readable medium storing instructions that, when executed by a processor, cause the processor to perform operations comprising:
detecting, by an on-cart computing system of a smart cart system, a change in contents of a storage area of the smart cart system based on sensor data captured by a set of sensors coupled to the smart cart system;
determining, based on the sensor data, that an item has been removed from the storage area of the smart cart system by a user of the smart cart system;
responsive to detecting the change in the contents of the storage area, capturing an image using a camera coupled to the smart cart system;
applying an item identification model to the captured image to identify the item removed from the storage area of the smart cart system, wherein the item identification model is a machine-learning model that is trained to identify items based on images that depict the items;
identifying a plurality of candidate items based on location data captured by a location sensor of the smart cart system, wherein the location data describes a location of the smart cart system when the item was removed from the storage area of the smart cart system;
computing a presentation score for each of the plurality of candidate items based on item data describing the item removed from the smart cart system and item data describing a corresponding candidate item;
selecting a candidate item for presentation to the user based on the computed presentation scores for the plurality of candidate items; and
updating a display of the smart cart system to present content describing the selected candidate item.
